(19) United States
(12) Patent Application Publication
(10) Pub. No.: US 2008/0008044 A1
(43) Pub. Date: Jan. 10, 2008

(54) Mobile acoustic event detection, recognition and location system

(75) Inventors: Frank Patterson, Woodward, OK (US); Bryan Noland, Woodward, OK (US); Reed Jules Oppenheimer, Tulsa, OK (US); Judson M. Gudgel, Tulsa, OK (US)

Correspondence Address: PAUL S MADAN;MADAN, MOSSMAN & SRIRAM, PC, 2603 AUGUSTA DRIVE, SUITE 700, HOUSTON, TX, 77057-5662, US

(73) Assignee: Patterson Research. Inc., Tulsa, OK (US)

(21) Appl. No.: 11/482,899

(22) Filed: Jul. 7, 2006

(51) Int. Cl. G01S 3/80

(52) U.S. Cl. 367/128; 367/906

(57) ABSTRACT

A system for detecting acoustic events comprising a wearable sensor comprising: a microprocessor; a microphone communicating with the microprocessor; a GPS module; a wireless network system; and a display screen; wherein: the microphone is in communication with the microprocessor allowing the microprocessor to detect the acoustic event; the GPS functions to determine the location of the wearable sensor; the wireless network system allows for the interfacing and sharing of data between the sensor and other components of the system for detecting acoustic events; and the system for detecting acoustic events functions to triangulate the location and time of the acoustic event, may be used to detect gunshots. Other acoustic events such as a patient alarm may also be detected using the system.

### BACKGROUND OF THE INVENTION

1. Technical Field

The present invention relates to acoustical event recognition and location system and a method for using same. The present invention particularly relates to such a system and method wherein the acoustical event recognition and location system is mobile.

2. Background of the Art

A few large cities have become plagued with gunfire. This gunfire may be both related and unrelated to the criminal community. For example, gunfire associated with celebrations has been known to cause injury and death. Similarly, gunfire associated with gang activity may be slow to be reported to the authorities resulting in loss of life due to delays in getting medial attention to injured victims

Some of the cities have adopted location systems that have proven effective in the location of the gunfire. Such systems, sometimes referred to as “gunshot detection systems” are generally known and available. Such systems can be used to detect the source of an acoustic event, the radial direction of an event and/or the general proximity of an event.

While useful in civil situation, such systems have obvious utility in martial situations. Sniper fire, for example, may be more effectively suppressed with better intelligence regarding the location of the sniper. Locating hidden heavy weapons positions may also be useful to soldiers in time of war.

### SUMMARY OF THE INVENTION

In one aspect, the invention is a man wearable acoustic sensor comprising: a housing configured to be man wearable; a microphone; a processor housed in said housing, said processor in communication with said microphone to detect an acoustic event and determine a time of arrival for said acoustic event; a GPS receiver in communication with said processor for providing position information to said processor; a network interface; and a display for displaying information concerning said acoustic event to a user.

In another aspect, the invention is a portable sensor for detecting and providing a time of arrival of an acoustic event produced in the environment comprising: a housing configured to be man wearable; a microphone acoustically coupled to the environment, such that said microphone provides a signal representative of acoustic waves received at said sensor; a microprocessor housed in said housing, said microprocessor being in electrical communication with said microphone such that a digital representation of said signal is present in said microprocessor; an absolute time clock in digital communication with said microprocessor such that said microprocessor can obtain synchronized time from said absolute time clock; and a network interface in digital communication with said microprocessor such that said microprocessor can communicate over a wireless network, wherein when a predetermined event is received at said microphone, said microprocessor obtains a time of arrival from said absolute time clock and transmits said time of arrival over said wireless network.

In yet another aspect the invention is a system for detecting acoustic events comprising a wearable sensor comprising: a microprocessor; a microphone communicating with the microprocessor; a GPS module; a wireless network system; and a display screen; wherein: the microphone is in communication with the microprocessor allowing the microprocessor to detect the acoustic event; the GPS functions to determine the location of the wearable sensor; the wireless network system allows for the interfacing and sharing of data between the sensor and other components of the system for detecting acoustic events; and the system for detecting acoustic events functions to triangulate the location and time of the acoustic event.

### DETAILED DESCRIPTION OF THE INVENTION

The present invention is a system and method for the detection and location of an acoustic or seismic event using a small, and highly portable, wearable total detection location system. In one embodiment, the detection system is incorporated into a larger systems such as that disclosed in U.S. Pat. No. 5,973,998 to Showen, et al., which is fully incorporated herein by reference. The Showen, et al., system has the sensors placed at a density of up to 10 units per square mile. Audio information is sent to a central computer and processed for the detection of the event, and to calculate the time of arrival, and the location. In the practice of the present invention, at least one of the sensors would be portable.

In another embodiment, the system of the present invention would incorporate at least one portable component, the portable component being a portable version of the system disclosed in U.S. Pat. No. 6,847,587 to Patterson, et al., which is fully incorporated herein by reference. In this embodiment, the portable component is a portable sensor that processes audio information within each sensor. Included in the information processed is the location of an acoustical event, such as a gunshot, and the time of arrival. That information can be transmitted to other sensors and to a central command center such as is used in military operations. Desirably, the units can be networked and information shared in real time, thus yielding information that can be delivered while still relevant.

In another embodiment, the portable component may be a portable version of a of at least one component such as is disclosed in U.S. Pat. No. 5,703,835 to Sharkey, et al., which is fully incorporated herein by reference. In this reference a security system for detecting a gunshot event is disclosed. This system includes a communication link, and a number of pole units are arranged in a dense grid. Each one of the pole units includes a microphone and a signal conditioning and thresholding unit coupled to the microphone. The signal conditioning and thresholding unit outputs a detection signal in response to an event when an output signal from the microphone exceeds a peak background average. A data acquisition and signal processing unit is coupled to the signal conditioning and thresholding unit for discriminating gunshot events.

In still another embodiment, the portable component is a portable version of at least one component as is disclosed in U.S. Pat. No. 5,455,868 to Sergent, et al., which is fully incorporated herein by reference. In this system, an amplitude responsive detection system analyzes the amplitude characteristic of a received noise and determines whether that characteristic conforms to the predictable audio signature of a gunshot. If a received noise reaches a predetermined amplitude level within a rise time that may be indicative of a gunshot, subsequent amplitude criteria are established representing the decay of the amplitude profile that is expected if the noise is a gunshot. The amplitude criteria are controlled as to both level and occurrence in time to provide a dynamic range that will accommodate near and far gunshots.

In one embodiment of the invention, some or even all of the sensors would be portable such that they may be worn by a soldier or law enforcement officer. Other components may be also be portable, but of a lesser degree. For example larger component may be carried as in the case of a squad leader carrying a central processor for facilitating networking and data sharing. Preferable, all of the equipment necessary for a user to take offensive or defensive actions would be sufficiently portable to be wearable. In such a preferred embodiment, the wearable components would include: a microphone for receiving acoustic events; an amplifier and possibly other signal conditioning circuitry; a processor, typically a digital signal processor, having an analog to digital converter; a GPS receiver and its associated antenna; and an interface for communicating via a communication network.

In one preferred embodiment of the invention, a sensor may be incorporated into a “wristwatch” like housing which can be worn strapped to the users' wrist and, in an alternative embodiment the sensor may additionally output current time thus serving a dual function. The GPS and communication antennae may be housed internally or incorporated in a watchband. Additional elements of a wrist worn sensor may include manual controls to allow scrolling through display screens and to allow the mode of operation to be changed; a windscreen or other device to reduce wind noise received by sensor and protect the microphone from weather and from minor impacts. In one preferred embodiment, the sensor has an exterior color which will blend with the soldier's uniform and/or the environment and thus not compromise camouflaging. In still anther alternative embodiment, the wrist worn system would house a host system. In such a configuration, a display could be used to display the location of any soldier in the squad, historical details, receive messages up and down the chain of command, as well as display current shooter information when the squad is fired upon.

In another embodiment, the sensor can be mounted in a hat or helmet. In such a configuration the components may be largely hidden by helmet shell. Preferably if shell is formed of a composite material, a GPS patch antenna or phased array is laminated directly in shell. When the sensor is incorporated into hat or helmet, the senor includes a display that may be flipped down for use and up and out of the way when not in use. The hat or helmet sensor may alternatively house the host processor, in which case it can be used to further display administrative information, individual soldier positions, and the like, as well as shooter location. In another configuration, the display associated with the hat or helmet sensor may be used to display information from other systems such as a night vision display, or even as a display for gunshot detection sensors incorporated into body armor or otherwise worn by the soldier. Similarly, the microphone of the sensor may function as microphone for a walkie-talkie.

In still other embodiment, the sensor may be worn attached to the shoulder, or as already mentioned incorporated into body armor. For purposes of the present application, the terms “worn” and “wearable” include embodiments where the portable sensor is attached to or incorporated within equipment that is carried or worn on the body. For example, embodiments where the sensors are incorporated into or attached to weapons such as a rifle, are also within the scope of the claims of the invention. Example of such uses include but are not limited to mounting sensors on rifles and other weapons, incorporating sensors into cell phones, radios or walkie-talkies; incorporation within vests, utility belts or holsters, and incorporation within badges. In one embodiment, the senor is carried within the pocket of a daypack. With all of these embodiments, the inclusion of displays, manual controls, and the like and dual utility as described above may be implemented. For example, when the sensor is attached to a rifle, the display may do dual duty as a sighting scope. Similarly, the sensor may be attached in such a way that it does not cause problems in use such as is the case where a sensor has square corners or sharp edges.

In one application, the sensor includes a display and the display functions as a heads-up display. The term heads-up display, for the purposes of the invention includes any display that allows for a viewer to see both projected data on the display as well as view the viewer's environment through the display. For example, where a scope servers as a display, a viewer may see both projected data relating to the location of an event and the target at which the scope is aimed.

It should be noted that when a sensor, or host, is used with an external or associated display, as opposed to an integrated display, that a communication means is required between the sensor and the display. By way of example and not limitation suitable communication means include: a digital radio link; infrared; wireless Ethernet; Bluetooth; and the like. Preferably, such a link is of minimal power and transmits intermittently to avoid detection by opposing forces.

The portable sensors of the invention include a power supply, such as a battery. In a preferred embodiment, the power supply is integrated into the sensor.

The portable sensor of the invention may also include an interface for accessing other systems. In one embodiment, the interface is configured to interface an Ethernet interface.

It should also be noted that while preferred embodiments of the present invention have been described in connection with gunshot location systems, the techniques for providing a convenient means for equipping a soldier or police officer with a wearable gunshot detection sensor can be applied to other types of systems, such as those monitoring health conditions, environmental conditions, and the like. For example, a patient alarm of a falling patient may be detected in a medical care facility.

The following example is provided to more fully illustrate the invention. As such, it is intended to be merely illustrative and should not be construed as being limitative of the scope of the invention in any way. Those skilled in the art will appreciate that modifications may be made to the invention as described without altering its scope.

### EXAMPLES

### Hypothetical Example 1

A sniper fires at a member of a squad of soldiers. At least two of the soldiers in the squad are wearing sensors of the invention. The report from the snipers weapon is received at the at least two sensors, the audio signal is conditioned and digitized and processed to detect the gunshot. Upon detecting a gunshot, a time of arrival and sensor position are obtained from a GPS receiver and transmitted to a host system. The location of the sniper at the time of the attack is transmitted to the squad whereupon some members take cover and other members take actions to neutralize the sniper.

What is claimed is:

1. A man wearable acoustic sensor comprising:
a housing configured to be man wearable;
a microphone;
a processor housed in said housing, said processor in communication with said microphone to detect an acoustic event and determine a time of arrival for said acoustic event;
a GPS receiver in communication with said processor for providing position information to said processor;
a network interface; and
a display for displaying information concerning said acoustic event to a user.

2. A portable sensor for detecting and providing a time of arrival of an acoustic event produced in the environment comprising:
a housing configured to be man wearable;
a microphone acoustically coupled to the environment, such that said microphone provides a signal representative of acoustic waves received at said sensor;
a microprocessor housed in said housing, said microprocessor being in electrical communication with said microphone such that a digital representation of said signal is present in said microprocessor;
an absolute time clock in digital communication with said microprocessor such that said microprocessor can obtain synchronized time from said absolute time clock; and
a network interface in digital communication with said microprocessor such that said microprocessor can communicate over a wireless network,
wherein when a predetermined event is received at said microphone, said microprocessor obtains a time of arrival from said absolute time clock and transmits said time of arrival over said wireless network.

3. A system for detecting acoustic events comprising
a wearable sensor comprising:
a microprocessor;
a microphone communicating with the microprocessor;
a GPS module;
a wireless network system; and
a display screen;
wherein:
the microphone is in communication with the microprocessor allowing the microprocessor to function to detect the acoustic event;
the GPS functions to determine the location of the wearable sensor;
the wireless network system allows for the interfacing and sharing of data between the sensor and other components of the system for detecting acoustic events; and
the system for detecting acoustic events functions to triangulate the location and time of the acoustic event.

4. The system of claim 3 wherein the wearable sensor is incorporated into a hat or helmet.

5. The system of claim 3 wherein the wearable sensor is incorporated into a vest, or carried in a utility belt or day pack pocket.

6. The system of claim 3 wherein the wearable sensor is attached to a weapon or body armor.

7. The system of claim 3 wherein the wearable sensor is incorporated into a cell phone, radio, or walkie-talkie.

8. The system of claim 7 wherein the microphone of the sensor also functions as a microphone for the cell phone, radio, or walkie-talkie.

9. The system of claim 3 wherein the display of the sensor has a dual function.

10. The system of claim 9 wherein the display functions as a targeting scope.

11. The system of claim 10 wherein the display functions to display data regarding the location of the wearer.

12. The system of claim 9 wherein the display functions as a night vision display.

13. The system of claim 3 additionally comprising a power supply.

14. The system of claim 13 wherein the power supply is a battery.

15. The system of claim 14 wherein the battery is integrated into the sensor.

16. The system of claim 3 additionally comprising a network interface.

17. The system of claim 16 wherein the interface is an Ethernet interface.

18. The system of claim 16 wherein the interface is a Bluetooth interface.

19. The system of claim 3 wherein the acoustic event is a gunshot.

20. The system of claim 3 wherein the determination of the time and location of the acoustical event is done in real time.
